(19) United States
(12) Patent Application Publication
(10) Pub. No.: US 2010/0169647 A1
(43) Pub. Date: Jul. 1, 2010

(54) Data Transmission

(75) Inventors: Gisle Grimen, Jakobsli (NO); Christian Monch, Trondheim (NO)

Correspondence Address: SUTHERLAND ASBILL & BRENNAN LLP, 999 PEACHTREE STREET, N.E., ATLANTA, GA, 30309, US

(73) Assignee: SECUSTREAM TECHNOLOGIES AS, Trondheim (NO)

(21) Appl. No.: 12/446,263

(22) PCT Filed: Oct. 29, 2007
(86) PCT No.: PCT/GB2007/004122

§ 371 Date: May 27, 2009

(30) Foreign Application Priority Data
Oct. 27, 2006 (GB) 0621437.3
May 30, 2007 (US) 60940746

(51) Int. Cl. G06F 15/16; G06F 9/44; H04L 9/32; H04L 9/00

(52) U.S. Cl. 713/175; 709/217; 717/106; 709/203; 380/46; 717/115; 713/168; 380/44

(57) ABSTRACT

A method of and apparatus for transmitting data in systems such as computer networks, for example in client-server or peer-to-peer arrangements. Access to transmitted data received by a destination apparatus is limited by the provision of software code at the destination apparatus. The software code is arranged to produce a result which is a function of the state of the destination apparatus, and this result is used to access the data. The software code may be either transmitted to the destination apparatus, for example along with the data it is used to access or from a separate server, or may be generated at the destination apparatus. The method and apparatus is particularly applicable in the field of on-line gaming, wherein the transmitted data is encrypted gaming data and the result of the software code provides the access key to the encrypted data.

The present invention relates to the transmission of data in systems such as computer networks, whether in peer-to-peer or client-server arrangements. In particular, it relates to a system that can be applied to prevent cheating in on-line games.

Multiplayer online games are rapidly growing in popularity. Successful games like World of Warcraft attract millions of players, creating considerable revenues. These revenues are endangered if players manage to cheat in order to get unfair advantages over other players. An online game that falls victim to cheating will rapidly lose its attractiveness and its players, thereby reducing its revenues. Thus cheating becomes a real threat to the profitability of multiplayer online games.

Since today's online games are complex applications, which interact with players in increasingly complex ways, they are susceptible to a number of different cheats. Cheating in multiplayer online games is possible for two main reasons: distribution and complexity. Multiplayer online games have to provide some kind of client program with which the player participates in the game. This is executed on the player's host and can therefore be analyzed and modified by the player. Game-client modifications and manipulations can give a cheat major advantages over an honest player. Modification might include code modification of the client and/or information extraction and manipulation.

In the present specification, any user of a game is referred to as a player. The player interacts with the game through a software program referred to as a game client. The game-client may communicates with a game server, which controls the game and interaction amongst players. The game-client is generally executed by the player on the player's computer. The game server might be executed as part of the game client or executed by a remote computer, either by another player or the owner of the game. Some game clients act at the same time as game servers and interact symmetrically with a number of other game client/game-server combinations. We refer to these client/server combinations as peers. In the remainder of this specification we will sometimes use the term game-client for all game components that are executed on a player's host. A cheating player who seeks to get an unfair advantage over other players is referred to as an attacker.

A possible solution to the problem of such cheating would be to perform all game-related calculation on a trusted game-server and reduce the game-client to a simple interaction front end for the game-server. While this approach eliminates a number of cheating possibilities, it puts a high load on game-servers. In online games, scalability of game-servers is already a major problem, so this is not regarded as a feasible solution.

Another possible solution, which does not require a trusted server, is to replicate the complete game processing at all players' hosts. In this case the game-client is a combination of a game-client and a game-server. These game-clients form a peer-to-peer network and all game-clients process the same events. This approach eliminates the possibility of cheating through game-client modification. However, in such a peer-to-peer configuration, the complexity of the game is then limited by the client with the lowest resources, since every client has to be able to process the whole game. Another problem with this solution is that all state information is stored in all peers. This might allow a cheat to access state information, which he should not see. In addition this configuration requires tight coupling between the game-clients, which in turn requires high quality network connections between the clients (high bandwidth, fast round trip, no delays).

There is therefore a need for a technology that prevents access to information in the game-client and therefore prevents cheating through information extraction or manipulation. Unmodifiable clients that are protected against information extraction would provide a number of advantages to online games. Firstly, unmodifiable, shielded clients would prevent all cheating that is performed by modifying or tapping the game-client's memory. Secondly, they would allow calculations to be safely distributed among game-clients, enabling game developers to leverage the large distributed computing facility that a large group of players offers. Thirdly, they would move online games from the class of distributed application that have to deal with the so-called Byzantine generals problem (see Leslie Lamport, Robert Shostak, and Marshall Pease. The Byzantine generals problem. ACM Trans. Program. Lang. Syst., 4(3):382-401, 1982.) to the class of distributed applications that have to deal with communication failures. This would allow game developers to concentrate on the game-related aspects when designing the interaction between clients and servers.

The inventors have recognised that protection mechanisms will not be reliable if they are statically integrated into the game-client. Since the game-client is completely exposed to an attacker, every protection mechanism that is contained within it will also be exposed to an attacker. This makes the protection mechanisms themselves vulnerable to attacks, since an attacker has virtually unlimited time to analyze and subsequently bypass them. Consequently, the integrity of the protection mechanisms cannot be guaranteed and their correct execution cannot be assumed if they are statically integrated into the game-client.

According to one aspect of the present invention there is provided a method of transmitting data from a source apparatus to a destination apparatus, wherein software code is additionally provided at the destination apparatus, the software code being arranged to produce a result which is a function of the state of the destination apparatus and which result is used to access data sent to the destination apparatus.

The source and destination apparatuses will typically be respective first and second computers and these will commonly be arranged within a network. However, as will be discussed further below, the invention has applications beyond computer networks. Also, whilst in most cases the software code will be transmitted to the destination apparatus from elsewhere, it is possible for the software code to be generated locally using a specification language. Thus, in a peer-to-peer network, it is not necessary to actually send Mobile Guards to peers. Instead every peer creates its own Mobile Guard according to the specification and executes it.

The result of executing the software code may enable the data to be accessed by providing a key which enables the data to be decrypted, preferably by or at the destination apparatus.

The invention also extends to a corresponding system and so, according to another aspect, there is provided a computer network comprising a first computer a second computer and a data path to enable data to be sent from the first computer to the second computer, wherein means is provided to transmit software code to the second computer, the software code being arranged to produce a result which is a function of the state of the second computer and which result is used to access data sent to the second computer.

In one example, the first computer is a game server the second computer is a game-client and the encrypted data is game data transmitted from the game server. Thus, the game data can only be used by the game client if the state of the game client causes the software code, when executed at the game client, to produce the result (a key) which allows the game data to be decrypted. Needless to say, there may be any number of game clients. Furthermore, as will be described more fully below, the system may also be applied to peer-to-peer arrangements.

Preferably, the software code is arranged such that the correct key is only generated if the game client is unmodified, either entirely, or in some significant respect. Thus, by means of the invention, the game data can only be used by an unmodified game client.

The present inventors have already described the used of such software code, known as a “Mobile Guard”, particularly for use in the protection of streaming media, but also for applications such as gaming (see Gisle Grimen, Christian Mönch, and Roger Midtstraum. Software-based copy protection for temporal media during dissemination and playback. In the 8th International Conference on Information Security and Cryptology, volume 3935 of LNCS. Springer, December 2005.) In addition, their patent application PCT/GB2006/002619, (the content of which is incorporated herein by reference) further describes such use. However, those systems required the result of the mobile guard to be returned to the server. Although this has certain security advantages, it does require the provision of a “back channel” from client to server and additional data transmission step compared to the present invention.

Each Mobile Guard may be created with an individual set of protection mechanisms and downloaded to all game-clients.

Mobile Guards preferably have a limited lifetime. Thus, when their lifetime has expired, they are replaced with a new Mobile Guard, which contains new protection mechanisms. The frequency with which this is done may be varied depending on the level of security required. They preferably have a lifetime that is too short to enable any intellectual human-based attack on them to be worthwhile.

As will be described more fully below, in the most preferred forms of the invention, the Mobile Guard may be used to ensure the integrity of the protection mechanisms and also to dynamically change and extend the protection mechanisms used in a game.

The integrity of the protection mechanisms is ensured by the individual creation of the Mobile Guards and their limited lifetime. The individual creation forces an attacker to mount a new intellectual attack on every new Mobile Guard. An intellectual attack requires an understanding of each individual Mobile Guard and gaining this understanding is a time-consuming process. If the lifetime of Mobile Guards is shorter than the minimum time required to understand the Mobile Guard, then the protection algorithms are replaced before a successful attack can be performed. Consequently, the integrity of the protection algorithms is ensured during the lifetime of the Mobile Guard. It follows from this that preferably the Mobile Guards are sufficiently distinct from each other to prevent automated attacks, i. e. a new intellectual attack is required for every new Mobile Guard.

Furthermore, the downloading of protection mechanisms in the form of Mobile Guards allows for an easy extension of protection mechanisms. New protection mechanisms may preferably be added to the Mobile Guard.

In further preferred forms of the invention, steps are taken to ensure that all game-clients execute the Mobile Guard.

One way to enforce the download of Mobile Guards into game-clients, as well as their subsequent execution, is to leverage the players' continuous need for game-data. To ensure execution of Mobile Guards, their execution is made a precondition for access to game-data. More precisely, every Mobile Guard contains an algorithm which calculates a result that is necessary for the client to access the game data. This algorithm is referred to as an enforcement algorithm.

An example of an enforcement algorithm is an algorithm that calculates some unknown access-key. This access-key is required to access the game-data. Since the access-key is necessary to access the game data, and since the enforcement algorithm is contained in the Mobile Guard, and since the Mobile Guard is protected against modification, the only way for a client to acquire the key is to execute the Mobile Guard. Consequently, if a client can access game-data, it must have executed the Mobile Guard.

Preferably, each Mobile Guard contains at least one enforcement algorithm and zero or more protection algorithms. To enforce the execution of the protection mechanisms, they are preferably functionally and spatially entangled with the enforcement algorithm, for example substantially as described in David Aucsmith. Tamper Resistant Software: An Implementation. In Proceedings of the First International Workshop on Information Hiding, pages 317-333. Springer-Verlag, 1996. Preferably the algorithms are both spatially and functionally entangled. Spatial entanglement prevents an attacker from separating the protection algorithms from the enforcement algorithm. Functional entanglement ensures that the protection algorithms are executed whenever the enforcement algorithm(s) are executed. In other words, a game-client may in this way be indirectly forced to execute the protection algorithms in order to get access to game-data.

The software code (e.g. Mobile Guard) preferably comprises a checksum algorithm which operates on the game client with the result either being the decryption key or being used to generate such a key. It will be appreciated that preferably the mobile guards are generated quickly and automatically and that they should not be predictable. In the inventors' previously cited paper and patent application they described Randomly Created Checksum Algorithms (RCCAs) and these are preferably employed in the present invention.

RCCAs are deterministic checksum algorithms that are randomly created. Due to the random nature of RCCAs two different RCCAs will almost always calculate different checksums on the same input. In other words, the checksum an RCCA calculates over a certain input is not known a priori. But if one RCCA is applied multiple times to the same input, the result will be the same every time, i.e. every RCCA is deterministic. In addition RCCAs are created in such a way that there is a low probability for collisions. That means it is very unlikely that, for a given RCCA, two different inputs lead to the same checksum. These two features of RCCAs make RCCAs well suited for the realization of enforcement algorithms as well as for the realization of protection algorithms.

The inventors have previously published two approaches to create RCCAs (see Gisle Grimen, Christian Mönch, and Roger Midtstraum. Tamper protection of online clients through random checksum algorithms. In Dimitris Karagiannis and Heinrich C. Mayr, editors, Proceedings of 5th International Conference ISTA 2006, number P-84 in GI-Edition—Lecture Notes in Informatics (LNI), pages 67-79, May 2006 which is incorporated herein by reference).

Both methods allow the efficient generation of RCCAs and either may be used in the present invention. Thus, one approach which may be used takes a known checksum algorithm, e.g. MD5, and augments it with an input filter that is randomly configured. For example, the input filter may divide the input into blocks and reorder them before they are fed to the checksum algorithm. This approach creates a cryptographically secure checksum, where randomness comes from the random configuration of the input filters.

A second approach to the creation of RCCAs is based on composing hash functions from a small set of operators by randomly combining them. This approach does not guarantee that the created hash functions are cryptographically secure. But this is not necessary as long as the checksum is unknown to an attacker and only used once.

As discussed above, the software code should be run before the game data can be accessed. One way to ensure this in an online-game is to let the enforcement algorithm calculate a result that is necessary to access the game-data. As previously described, this result could be a key or part of a key or a token needed to correctly access game-data.

In order to provide a good level of security, this result preferably has one or more (ideally all) of the following properties. First, it should be unpredictable to an attacker. If that were not the case, its calculation would not be necessary, instead the attacker could record the result and replay it later. In addition the result must be deterministic, otherwise its correctness could not be verified. Second, the only way to obtain the result should be to execute the current Mobile Guard in the game-client.

The input for the RCCA is the code and data of the game-client or a part of it. The RCCAs are preferred because they fulfill all of the above requirements for an enforcement algorithm. Therefore the result of the RCCA is used to control access to the game-data.

RCCAs can enforce the execution of the Mobile Guard, because an attacker cannot modify or analyze the Mobile Guard in order to predict the result of the RCCA. The only way to retrieve the correct result is to therefore to execute the Mobile Guard. Consequently, every client which possesses the correct result has to have executed the enforcement algorithm. The use of the result of the RCCA as an access-key to game-data is termed, implicit result verification. The game-server preferably encrypts all game-data with the correct result and in the game-client all incoming game-data is decrypted with the result that is calculated by the RCCA. This is distinguished from the prior arrangements (termed explicit result verification) cited above where the result is returned to the server.

As discussed above, the software code preferably also comprises one or more so-called protection algorithms which protect sensitive game-data against access by an attacker, and which ensure the integrity of the game-client.

Preferably there is a protection algorithm which is arranged to prevent an attacker from accessing sensitive game-data by means of data hiding. Data hiding comprises applying a random mask to sensitive data. The masking makes it impossible for an attacker to understand the content of the data without analyzing the code. This prevents extraction of information from sensitive data and modification of sensitive data, which is stored in the memory image of the game-client.

To withstand attacks, data hiding should preferably be performed differently every time a new Mobile Guard is downloaded to the client. Otherwise an attacker could analyze an old Mobile Guard and determine the mechanism that is used to hide the data. Therefore the Mobile Guard creation preferably includes the creation of hiding functions that are used to implement data hiding. Reversible functions are preferably used as hiding-functions. These functions may be randomly created by the server that creates the Mobile Guard. Thus, the Mobile Guard may carry a schematic of the hiding functions. During its execution the Mobile Guard then applies the transformation to the game-data. This makes the game-data inaccessible to an attacker without an intellectual analysis.

To enable the game-client to access the game-data, the Mobile Guard will embed the hiding-functions directly into the game-client. Write access to game data may be augmented with the hide-function and read access to game data may be augmented with the inverse hide-function. If the hide function consists of the reversible functions: hide₁, hide₂, . . . , hideₙ, then the code sequence:

m:=x

that writes the sensitive data x to the memory location m is replaced with the code sequence:

x:=hide₁(x); x:=hide₂(x); m=hideₙ(x);

Read access to hidden data is processed likewise. The code sequence:

x:=m

that reads sensitive data from the memory location m and copies it to the processor's internal variable x, is replaced with the code sequence:

x:=hide⁻¹ₙ(m); x:=hide⁻¹ₙ₋₁(x); x:=hide⁻¹₁(x);

where hide⁻¹ is the inverse hide function.

By this means, as the modifications are embedded into the game-client, the game-clients can hide and unhide the data in CPU registers, without the need to have large parts of sensitive data unhidden in memory. For the sake of economy and speed, preferably, the hiding functions are only added to instructions that handle sensitive data.

The insertion of code sequences can be done in different ways. The client program could, for example, contain empty areas in front of the instructions that access sensitive data. The hide- and unhide-functions could then be inserted into these areas. Another way to integrate the hide-functions, that can be combined with the previous one, would be to reserve space for an appropriate jump-instruction in front of the instructions that access sensitive data. The hide-and unhide-functions could then be placed somewhere in the code area of the game-client and the appropriate jump instructions would be inserted in the reserved area. A third way of inserting code sequences would be to relocate the game-client's code in order to create room to insert the hide- and unhide-functions at the appropriate places. In this approach one could, for example, move the basic blocks that contain the instructions that access sensitive data to a free memory area and enlarge them appropriately. This approach requires the adaptation of all references to the relocated basic block.

Data hiding prevents attacks that are based on monitoring or modifying data in the memory image of the game-client. This prevents, for example, external programs from extracting sensitive information from the memory image of the game-client. However, data hiding only works as long as an attacker has no automated way of extracting the hide- and unhide-function from the game-client. The difficulty of extracting hide- and unhide-functions is related to the amount of identical structures in the different Mobile Guards. The reason is that all identical structures can be exploited by an automated attack. A possible attack on data hiding might be to analyze the game-client in order to identify all instruction sequences, in which sensitive data is accessed. Equipped with this information an attacker might find a way to automatically extract the hiding-functions.

This attack would require resource intensive mechanisms. It is unlikely that a game-client can be executed in real-time when these mechanisms are in place. However, in the most preferred forms of the invention a protection mechanism may be provided that makes the automated extraction of hiding-functions considerably more difficult. This mechanism is termed code relocation and diversification.

Code relocation and diversification preferably performs one or both of two modifications on the game-client while it is executed. The first is relocation: it relocates the basic blocks that contain certain sensitive code sequences to new, randomly assigned, memory locations. This step includes the modification of the relocated and non-relocated code in order to keep the control flow intact.

The second is diversification: it modifies the relocated instruction sequences by replacing them with instruction sequences that perform the same calculations but contain different instructions.

Even if an attacker should have identified the instruction sequences that access sensitive data intellectually, it will be infeasible for him to automatically re-identify this instruction sequences after code relocation and diversification has been performed. The relocation step makes it impossible for an attacker to re-identify code through its memory location. The diversification step makes it impossible to re-identify code by comparing instruction sequences.

As discussed above, an automated attack on hide- and unhide-functions poses a very difficult problem to an attacker, even without code relocation and diversification. Although code relocation and diversification make it infeasible to automate such an attack, code relocation and diversification are complex processes that might not be necessary for the majority of game-clients.

Another protection algorithm modifies the layout of data structures (for example, the number of elements, order of elements, representation of elements, etc.) in a randomly selected order. This change is preferably done by the Mobile Guard, which performs subsequent changes to the code to ensure that the data can be correctly accessed as before.

A third protection algorithm that may be incorporated ensures the integrity of the game client. In one arrangement, as already described, the RCCA can in principle be used to solve this task. In order to verify the integrity of the game client, the RCCA just has to be calculated over the code of the game client. In this case the correct result of the RCCA does not only verify the execution of the enforcement algorithm, but also that the RCCA was calculated with an unmodified client as input. Since the correct RCCA result is required to access the game data, every game client that actually accesses game data must have: (a) executed the enforcement algorithm including all protection algorithms, and (b) provided an unmodified game-client as input to the RCCA.

But the correct RCCA result does not always guarantee that the executed game-client is unmodified. The problem is that the RCCA treats code as data, while the CPU treats code as instructions. This leads to two different paths on which data and instructions respectively are transferred into the CPU. On modern hardware it is often possible to exploit this to attack checksum algorithms by setting up these paths differently. In this case, data reads would retrieve data from a different memory area from instruction fetches. An attacker could therefore execute a modified game-client, while the checksum algorithm would read unmodified code. By modifying the kernel, data accesses and instruction fetches are redirected to different memory areas, resulting in a fully automated attack without any considerable slowdown.

Such an attack may be prevented from succeeding by means of a further preferred feature of the invention which includes self-modification in the client. If the process of self-modification fulfils the following two conditions, the aforementioned attack cannot be performed on the game-client: (a) it must be impossible to automatically distinguish between checksum-related and self-modification-related memory accesses; and (b) the game-client must stop working if the self-modification is not performed.

If the game-client depends on self-modification to operate correctly, then an attacker has to make sure that all self-modification steps are performed. If, in addition, he has no way of automatically distinguishing between checksum-related and self-modification-related read accesses, the only way to perform the self-modification correctly is to direct data access to the same memory location as instruction fetches. If he does not do that, the self-modification would not be performed and the game-client would not work anymore. If he does that, the checksum will be calculated over the instructions that are self-modified, which are the instructions that are actually executed, and any modification in these instructions will be detected.

The preferred checksum-related and the self-modification-related instructions are contained in the Mobile Guard. With an appropriate entanglement and randomization of the Mobile Guard it becomes virtually infeasible for an attacker to automatically distinguish between checksum-related and self-modification-related data accesses.

Self-modification is performed when the data hiding mechanisms are executed, i.e. when the hiding-functions are inserted into the game-client as described above. It is clear that this self-modification step has to be performed, otherwise the game-client could not access sensitive game-data and would not work properly. The insertion of the hiding-functions is made dependent on data access to the code of the game-client. To achieve this, the Mobile Guard carries a schematic of the hiding-functions that has to be combined with randomly selected instructions of the current hiding-functions in order to obtain the correct new hiding-functions. In this way it may be ensured that hiding-functions are only then inserted correctly, if data reads actually accesses the code that is executed.

The invention extends to a network of computers comprising a game server and a plurality of game clients where the game server comprises a trusted Mobile Guard source arranged to transmit Mobile Guards to each of the game clients. The game server also transmits game data to the mobile guards which may only be accessed when the mobile guard determines that the game client has not been modified from a predetermined standard state (i.e. tampered with).

In an alternative arrangement, however, the trusted Mobile Guard source may be distinct from and/or remote from the game server. In such an arrangement, the game server may be unprotected, for example it may be a player's computer. In such a scenario, the game server's integrity may also be checked by means of the Mobile guards from the Trusted source. This arrangement may also be used in a peer-to peer communication arrangement where there is no game-server.

So far, for the sake of clarity, the invention has primarily be described in terms of one preferred application, namely on-line gaming. However, it is applicable to any situation where computers (or other electronic devices) need to communicate and there is a desire to ensure that one or more of them is running unmodified software (or indeed unmodified hardware). Thus, where, in the discussion above, the first computer has been discussed as a game server, it may be a server of any kind, for example in a conventional computer network (whether local, internet, etc.) and the second computer can be any computer running a client program. Furthermore, both the first and second computers may be peers in a peer-to-peer system.

Since the mobile guard can be supplied by a trusted third party, it is possible for hitherto unconnected parties to verify the integrity of each other's client programs in any context. This may be useful in secure e-mail communication, commercial transactions, etc.

The invention also extends to the Mobile Guard itself and so, viewed from another aspect the invention provides a software product suitable for being transmitted to a remote apparatus whereby the execution of the software product at the remote apparatus provides a result which is a function of the state of the remote apparatus and which, if the result is satisfactory, enables access to data by the remote apparatus. This is preferably by the means described above, for example by the result generating a decryption key for the data. The software product is preferably a Mobile Guard as described above and may be transmitted over a computer network such as the Internet.

The inventors have also appreciated that there are games in which no trusted Mobile Guard source is available. In these games the server is usually run by one of the players, or there is no dedicated server and the players' hosts execute peers. Since the authenticity of the player that runs the server can usually not be verified, downloading and executing a Mobile Guard from the server is not a viable solution because a malicious player might include malicious code in the Mobile Guard.

To address this situation, instead of downloading a Mobile Guard, the creation and application of random checksum algorithms may be performed locally. Thus, all participants in a game create their Mobile Guards themselves. Since they are peers or client/server combinations they already contain the possibility to create Mobile Guards. To do this it is necessary to ensure that all clients create the same Mobile Guard. Second it is necessary to ensure that the algorithms in the Mobile Guard are sufficiently randomized, i.e. e. that the RCCA is actually randomly created.

To enable all clients to create identical Mobile Guards a specification language is preferably used for Mobile Guards. This specification language preferably does not contain any executable code. It may be read by a Mobile Guard factory and directs the creation of a Mobile Guard.

The Mobile Guard factory is a part of the game-client. It reads a Mobile Guard specification and creates the Mobile Guard according to this specification. The Mobile Guard specification language is preferably complex enough to allow the specification of RCCAs and data hiding functions that cannot be simply analyzed. However, at the same time it should preferably be so restricted that it does not allow an attacker to influence the actual code generation in the Mobile Guard.

It has to be ensured, that Mobile Guards are created randomly, otherwise an attacker could predict the result of the RCCA contained in a given Mobile Guard. To randomly create Mobile Guards we may randomly elect one peer among the participants in the game. This peer will then randomly create a script in the Mobile Guard specification language. If the selected entity is changed repeatedly and if there are honest players in the game, it can be ensured, that at least one Mobile Guard will be created randomly. When this happens, dishonest players cannot participate in the game anymore.

Alternatively the script could be created cooperatively by the peers, making it impossible for a single peer to completely determine the structure of the resulting Mobile Guard.

It will be appreciated that by means of the present invention, many kinds of communication and interaction between computers and other devices may be facilitated. For example, the source apparatus may be a server providing streaming content and the destination apparatus may be a customer's computer running a suitable viewer program. By verifying the integrity of the viewer, it can be ensured that copy-protection features have not been disabled.

Since the invention requires no back channel, it can also be applied in contexts where none is available, for example in broadcast systems (terrestrial or satellite TV, etc.) In such an arrangement, the source apparatus is associated with the broadcaster and is the source of program content which is broadcast and the destination is associated with the customer's receiving equipment. Thus, it may be part of a TV, set-top box, etc. The Mobile Guards may be transmitted by the broadcaster along with the program, or it may be transmitted by a third party.

Thus, viewed from a still further aspect, the present invention provides a method of distributing media content comprising providing a transmission station which transmits encrypted media content and a customer's receiving apparatus, wherein there is also transmitted to the customer software code (e.g. a Mobile Guard as defined herein) which verifies the integrity of the receiving apparatus and enables the media content to be decrypted only if the receiving apparatus is found to be unmodified.

The transmission may be by broadcast, cable, satellite, etc. Preferably the mobile guard provides a result which is a decryption key for the encrypted data. The invention also extends to a corresponding transmission system and also to a set-top box arranged to execute a Mobile Guard.

Preferred embodiments of the present invention will now be described, by way of example only, and with reference to the accompanying drawings, in which:

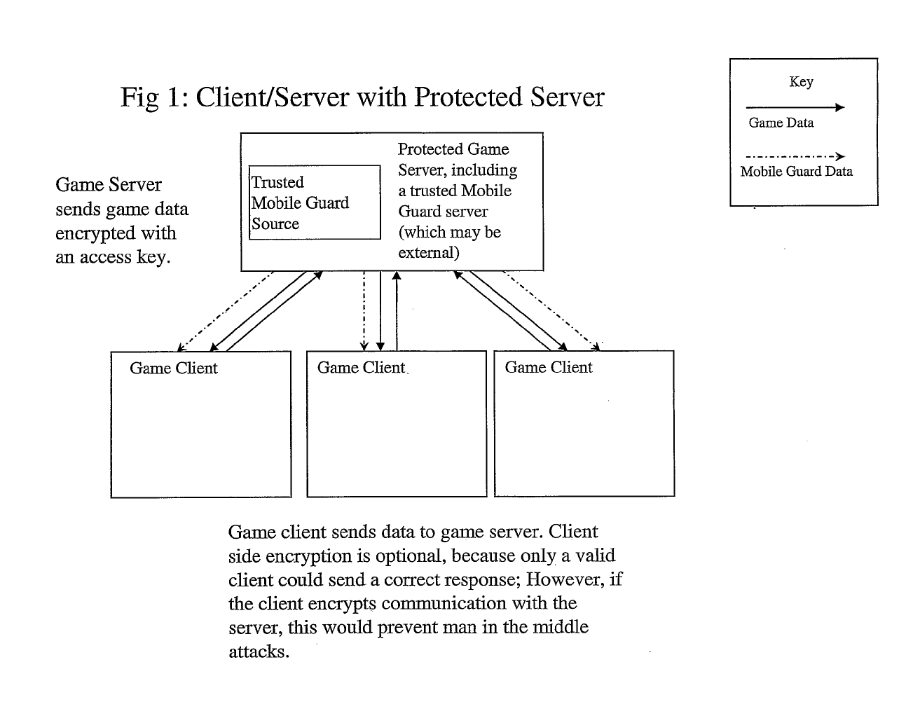

FIG. 1 is a schematic view of a client/server system with a protected server;

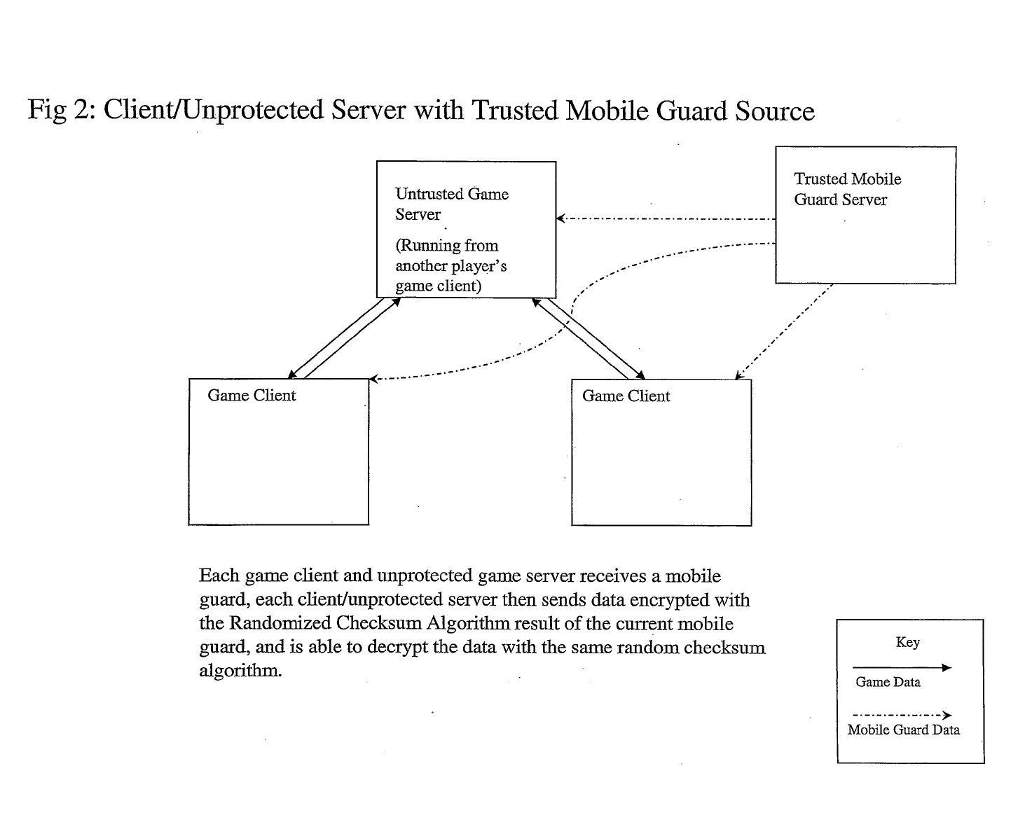

FIG. 2 is a schematic view of a client/server system with an unprotected server and a trusted Mobile Guard source;

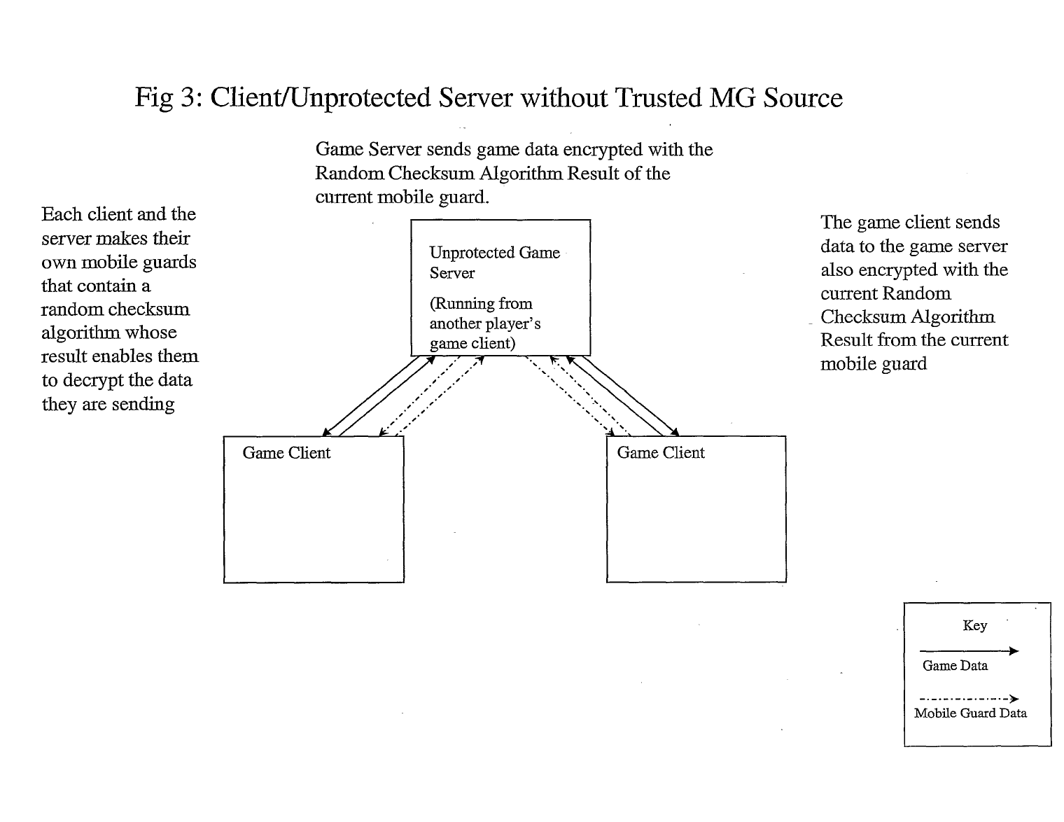

FIG. 3 is a schematic view of a client/server system with an unprotected server but without a trusted Mobile Guard source;

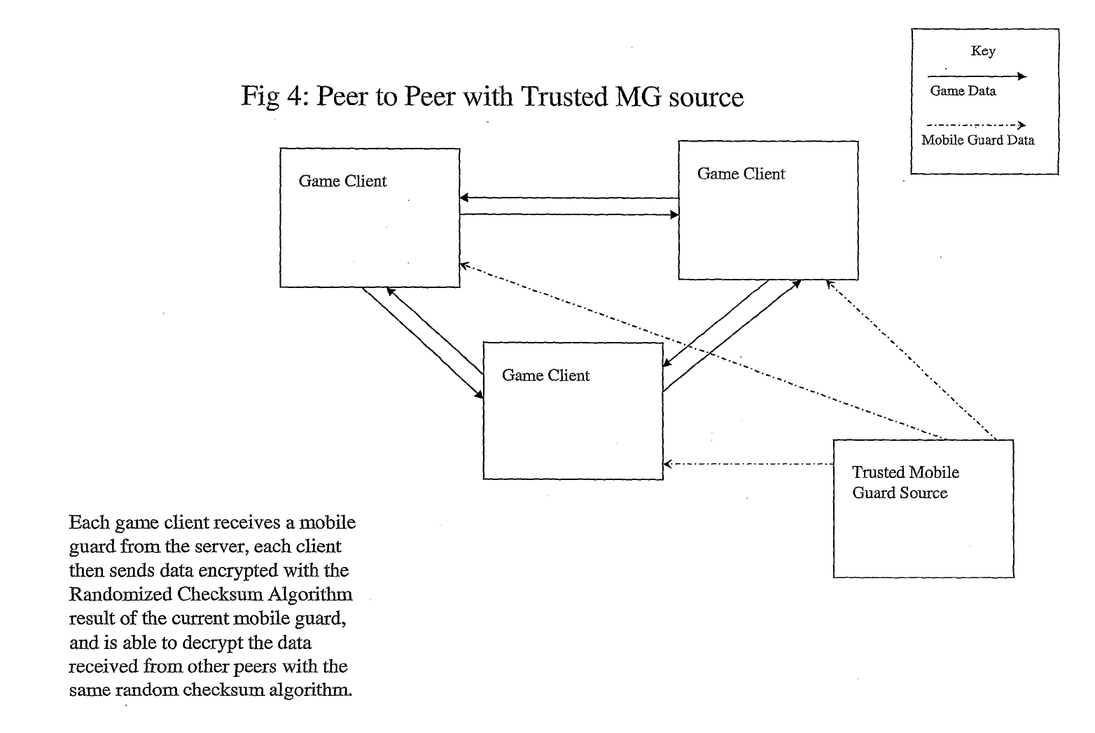

FIG. 4 is a schematic view of a peer-to-peer topology with a trusted Mobile Guard source;

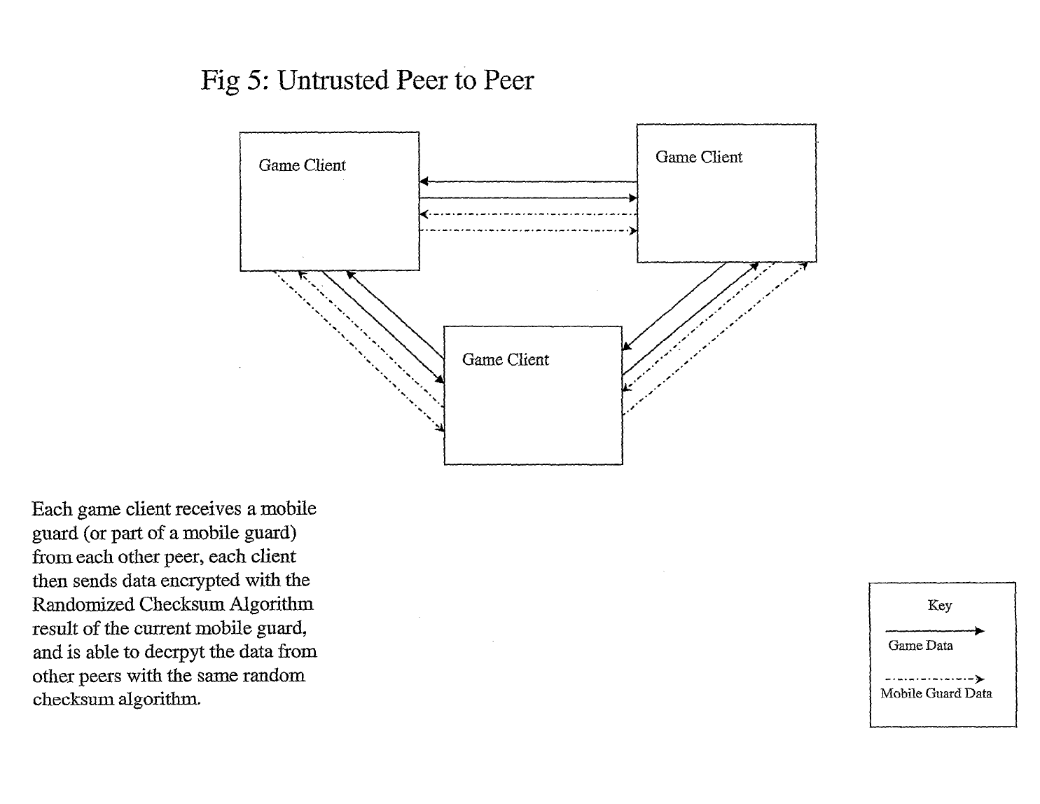

FIG. 5 is a schematic view of a peer-to-peer topology without a trusted Mobile Guard source;

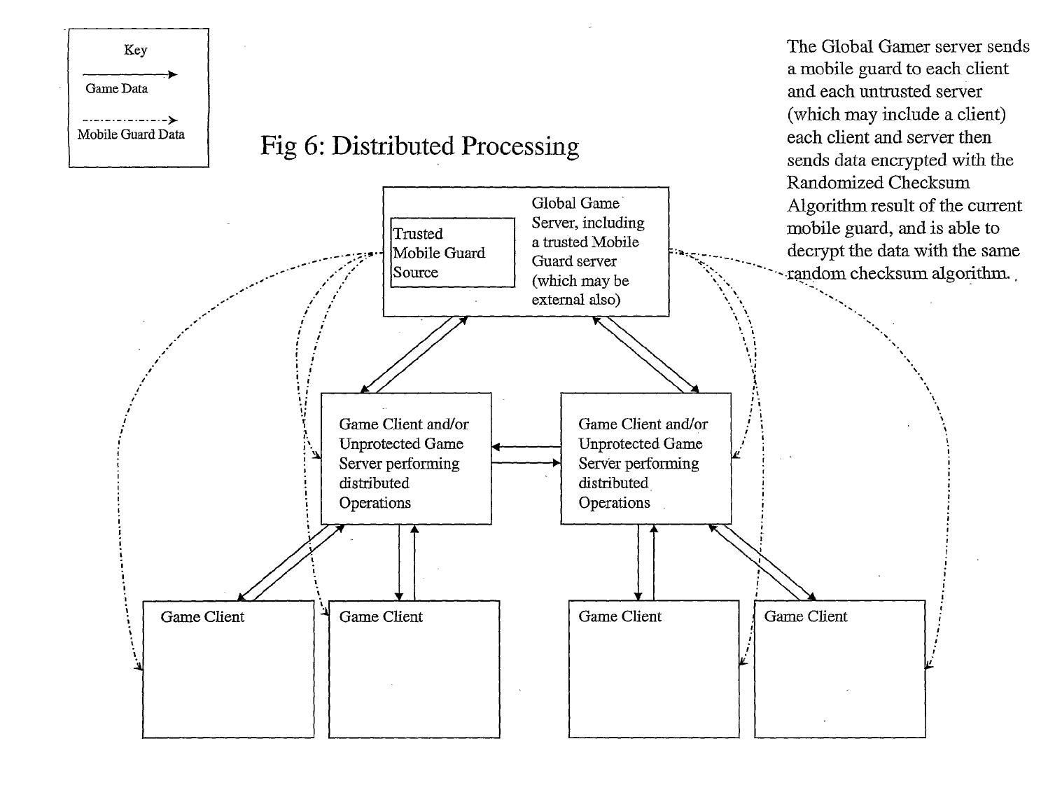

FIG. 6 is a schematic view of a distributed processing arrangement;

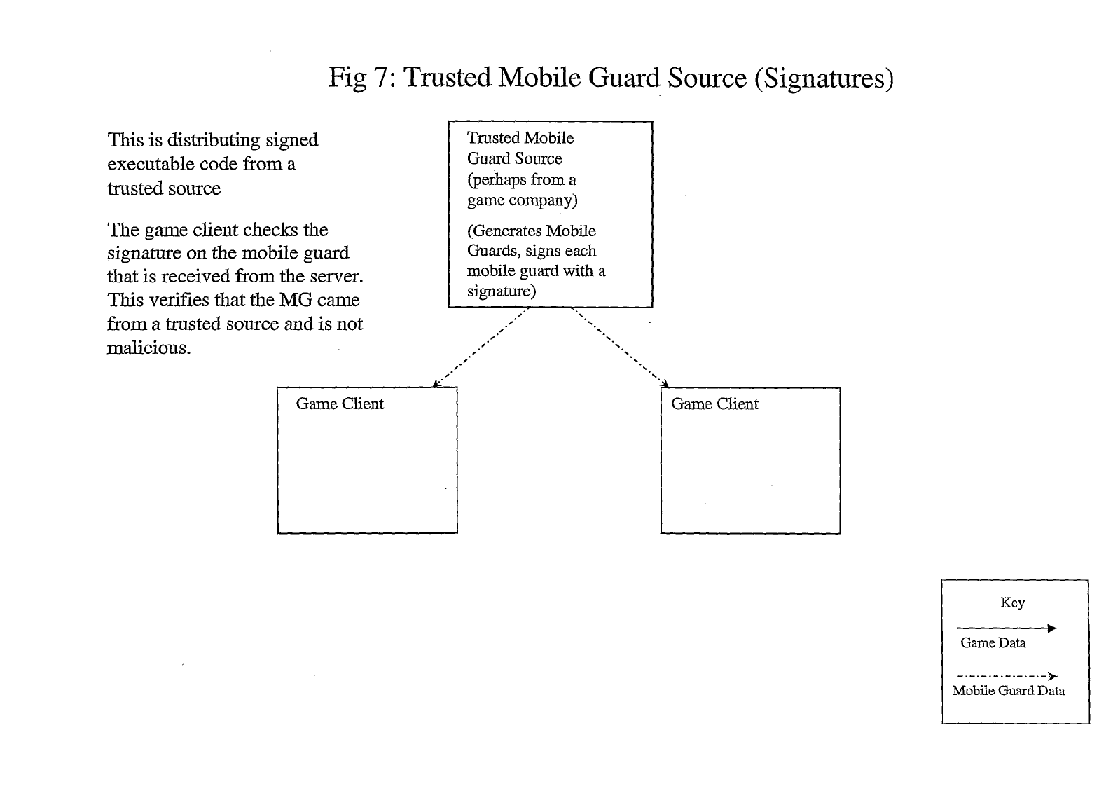

FIG. 7 is a diagram showing the use of a trusted mobile guard source employing a signature arrangement

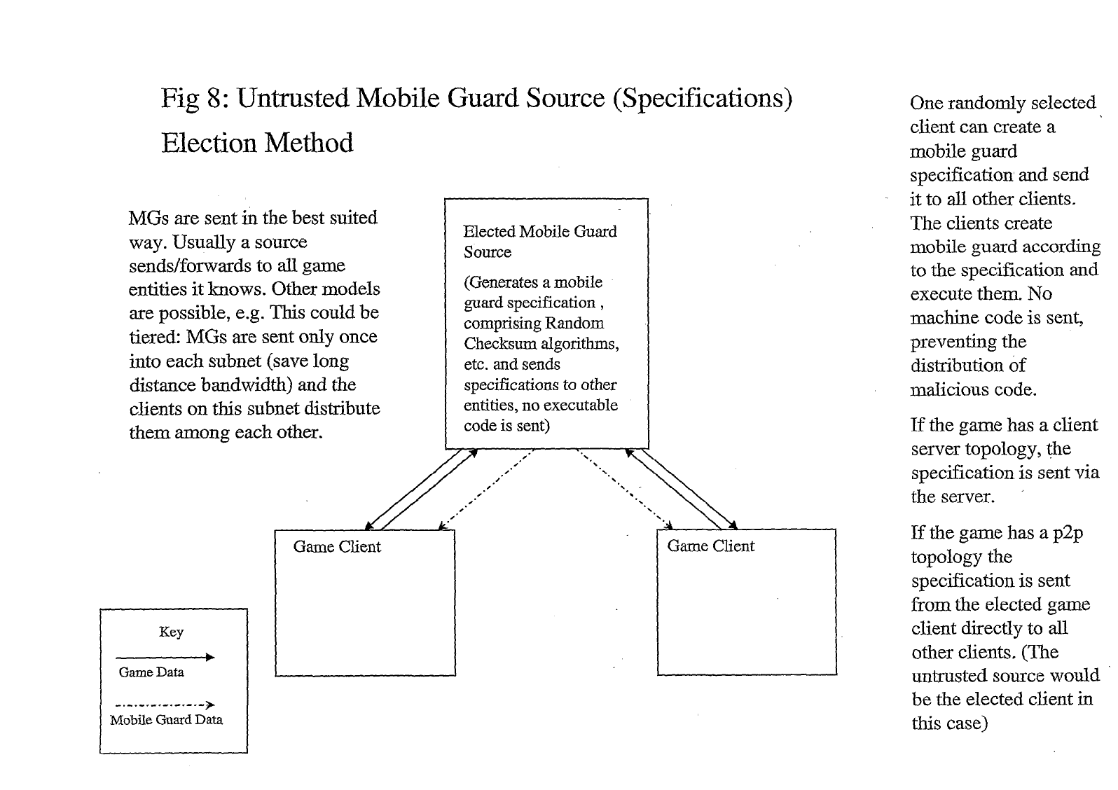

FIG. 8 is a diagram showing the generation of Mobile Guards using a specification generated at one client;

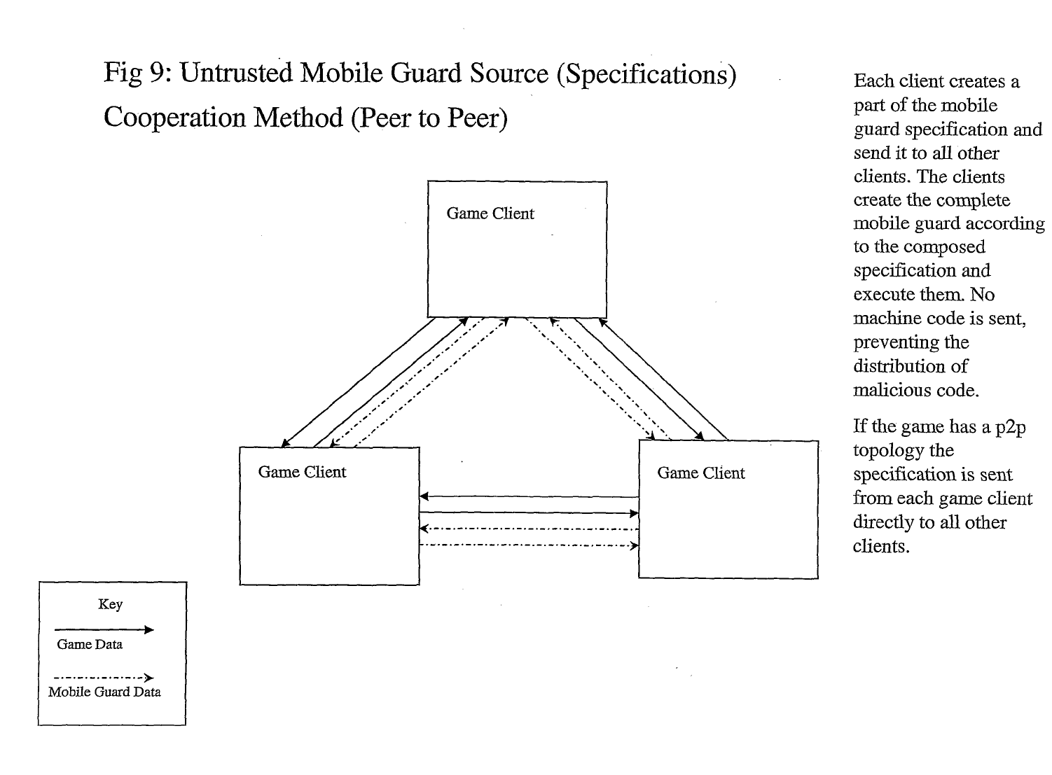

FIG. 9 is a diagram showing the generation of Mobile Guards using a cooperation between peers; and

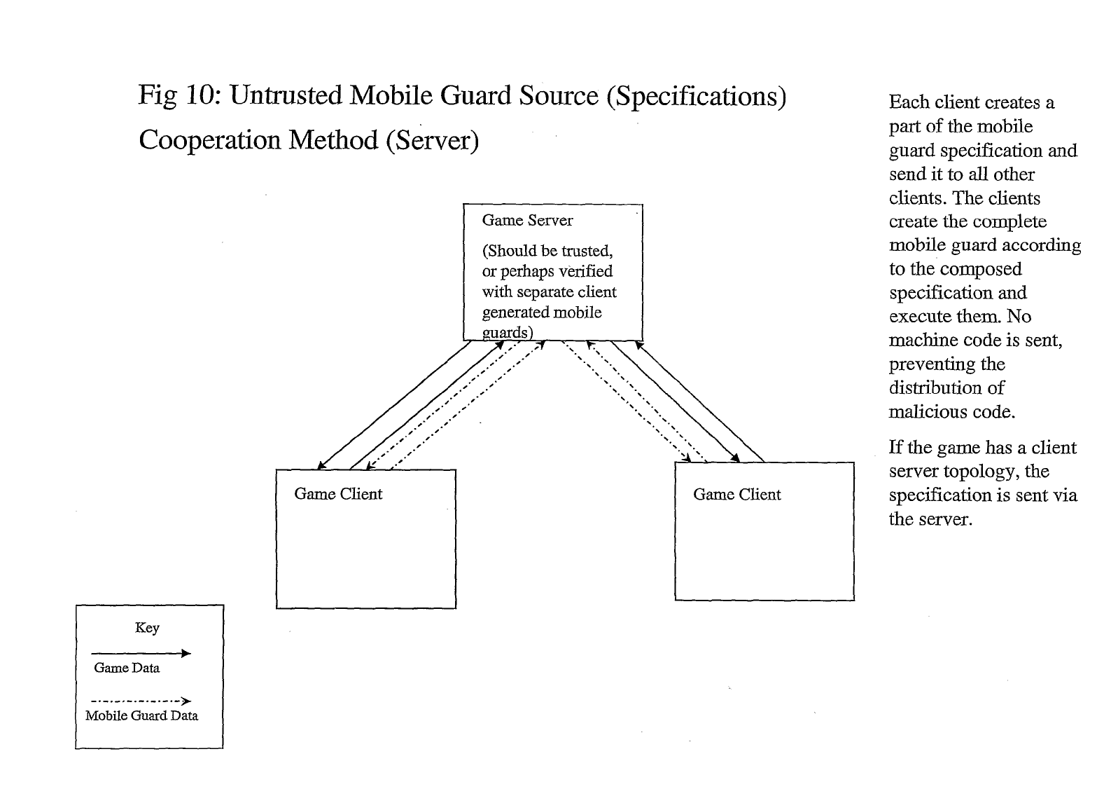

FIG. 10 is a diagram showing the generation of Mobile Guards using a cooperation method applied to a server/client system;

In the following embodiments, the invention is applied to protect game clients in different game configurations against tampering. Generally, if an entity s sends game-data to an entity r and this game-data is protected with the correct checksum then r can rely on the integrity of s. In each of the embodiments described, the Mobile Guards are in accordance with the preferred forms thereof described previously.

FIG. 1 illustrates a client/server arrangement where the server is protected against attacks, i.e. it is operated by the game provider. Examples for such games are World of Warcraft, and Everquest.

In this configuration only the game-clients need to be protected. Mobile Guards are distributed from the trusted source at the server to all game-clients. The protected server is informed about the access key. The protected server will encrypt all communication to game-clients with the access key and this ensures that only unmodified clients can participate in the game.

The communication from clients to the server does not have to be protected to ensure the integrity of the client. A client that can react on the messages sent by the server must have been able to decrypt the message it received from the server and must therefore be unmodified. On the other side, there is no need for the clients to encrypt messages to the server, because they trust it. Nevertheless, clients may encrypt their communication to the server in order to prevent cheating through man-in-the-middle attacks, for example, aim-hots or time-stamp modifications.

FIG. 2 shows a client/server system with an unprotected server, i.e. a client-server topology where the server is not protected against attacks, e.g. where it is operated by a player. Examples for games that use such a configuration are Quake III Arena, and Counterstrike.

In this configuration the game-clients and also the game-server need to be verified. The Mobile Guard is therefore distributed to the game-clients and to the game-server from a separate trusted source. A single Mobile Guard is created for game-clients and game-servers because in this configuration a game-client and a game-server are usually contained within the same program. That means that a checksum over the whole program will at the same time check the game-client and the game server, and that both, game clients and game servers, can calculate this checksum.

To verify the game clients, the server encrypts all outgoing messages with the current RCCA result. To ensure that the game-server is unmodified the game clients also encrypt all outgoing messages with the current RCCA result.

FIG. 3 corresponds to the situation of FIG. 2, except that there is no trusted Mobile Guard source. In this case, each client and server make their own mobile guards which are transmitted between client and server, and vice versa, as shown. Thus, the server sends encrypted content to the client and the client sends encrypted content to the server.

FIG. 4 is a peer-to-peer topology, i.e. every game client communicates with every other game client, where a trusted Mobile Guard source is available. In such an arrangement, all clients usually perform identical calculations. Examples for games that use such a configuration are Civilization IV, and Age of Empires II.

In the case of a peer-to-peer architecture, every game-client has to be verified. This is done in this embodiment by distributing the Mobile Guard to all peers. Every peer encrypts all outgoing data with the current RCCA result. In this way, if a peer receives a message that was encrypted with the correct access key, it can be sure that the sender is unmodified.

FIG. 5 shows a peer-to-peer arrangement where there is no trusted Mobile Guard source. Here, each game client receives a Mobile Guard, or part thereof, from another peer. Each client then sends data encrypted with the Randomized Checksum Algorithm result of the current mobile guard, and is able to decrypt the data from other peers with the same random checksum algorithm.

In the distributed processing topology of FIG. 6, game clients, or clusters of game clients, serve as servers for a number of other game clients. These serving game clients are termed as player-located servers. All player-located servers are usually controlled by some kind of protected game server. The protected game server distributes processing tasks among the player-located servers. This topology would, for example, allow the distribution of the calculations of MMOGs among clients. There are believed to be no examples of such topologies among contemporary games, although some research is being done on how to implement such a configuration.

To secure this topology with the technology of the present invention, game-clients and player-located servers have to be verified. From a protection point of view this configuration is quite similar to the client/server configuration with an unprotected server. Thus, Mobile Guards are distributed to all game clients and player-located servers, and they encrypt all outgoing messages with the current RCCA result. In addition, protected game servers encrypt all outgoing data with the current RCCA result. This ensures, that only unmodified game clients can communicate to unmodified player-located server. Only unmodified player-located server can interact with game-clients and with the protected game servers.

To make sure that the overall state of the game is not lost, the protected game servers could send Mobile Guards to player-located games servers only in exchange for the current state information.

It will be appreciated that the embodiments described above may obtain the mobile guard from alternative sources. There may be a trusted Mobile Guard source that is protected from attackers, but if this is not available, provide Mobile Guards can still be provided. These alternatives are now described further.

Referring now to FIG. 7, a large number of games contain servers that are operated by a trusted entity, usually the game developer. We refer to this server as a trusted source. An example of trusted sources are the servers that run World of Warcraft or the Steam platform.

In such a scenario, a natural choice for the source for Mobile Guards are these trusted sources. The trusted sources create Mobile Guards, which contain an explicit expiration time, at certain time intervals and distribute them to all participants in the game. The distribution of Mobile guards can be done directly, or through intermediary untrusted sources, e.g. peer to peer networks. A trusted source signs every Mobile Guards it creates. The game-clients contain certificates that allow them to verify the signature on the Mobile Guards in order to ensure that they actually originated at the trusted source. If this verification step is successful, a game-client can execute the Mobile Guard it received, without fear of executing malicious code. After a successful verification, the expiration time is checked and the mobile guard is used until it expires. As the trusted mobile guard source is aware of the expiration time of the currently active mobile guard, it will ensure that a new mobile guard is ready in time to be delivered to the clients before the old mobile guard expires.

The scheme described here does not require the establishment of new trust relations, since the player has already installed the game-client on his machine, which stems from the same source as the Mobile Guards.

FIGS. 8 to 10 illustrate further the situation where there is no trusted Mobile Guard source, e.g. games the server is usually run by one of the players, or there is no dedicated server and the players' hosts execute peers. Example for online games without trusted servers are Quake III Arena, Counterstrike, and Age of Empires II.

All participants in the game create Mobile Guards themselves. A specification language is used for these Mobile Guards. This specification language does not contain any executable code. It is read by a Mobile Guard factory and directs the creation of a Mobile Guard. The Mobile Guard factory is a part of the game-client. It reads a Mobile Guard specification and creates the Mobile Guard according to this specification. The Mobile Guard specification language has to be complex enough to allow the specification of RCCAs and data hiding functions that cannot be simply analyzed. At the same time it should be so restricted that it does not allow an attacker to influence the actual code generation in the Mobile Guard.

These Mobile Guards are created randomly. As shown in FIG. 8, one peer among the participants in the game randomly creates a script in the Mobile Guard specification language. If the selected entity is changed repeatedly and if there are honest players in the game, it can be ensured, that at least one Mobile Guard will be created randomly. When this happens, dishonest players cannot participate in the game anymore.

Alternatively, as shown in FIG. 9, the script is created cooperatively by the peers, making it impossible for a single peer to completely determine the structure of the resulting Mobile Guard. Thus, it is not necessary to actually send Mobile Guards to peers. Instead every peer creates its own Mobile Guard according to the specification and executes it.

Finally, FIG. 10 shows the approach of FIG. 9 applied to a server/client arrangement. Each client creates a part of the mobile guard specification and send it to all other clients. The clients create the complete mobile guard according to the composed specification and execute them and the specification is sent via the server.

We claim:

1. A method of transmitting data from a source apparatus to a destination apparatus, wherein software code is additionally provided at the destination apparatus, the software code being arranged to produce a result which is a function of the state of the destination apparatus and which result is used to access data sent to the destination apparatus.

2. A method as claimed in claim 1, wherein the source and destination apparatuses are source and destination computers arranged within a network.

3. A method as claimed in claim 1, wherein the software code is transmitted to the destination apparatus from elsewhere.

4. A method as claimed in claim 3 wherein the software code is transmitted from a trusted source.

5. A method as claimed in claim 3, wherein the software code is transmitted from the source apparatus.

6. A method as claimed in claim 1, wherein the software code is generated at the destination apparatus.

7. A method as claimed in claim 6 wherein the software code is generated using a specification language.

8. A method as claimed in claim 7 wherein the specification language does not contain executable code.

9. A method as claimed in claim 7, wherein the software code is generated using a script in the specification language.

10. A method as claimed in claim 9 wherein the script is created at the destination apparatus.

11. A method as claimed in claim 9, wherein the source and destination apparatuses are peers in a peer-to-peer system, said source also operating as a destination and said destination also operating as a source.

12. A method as claimed in claim 11 wherein the peers are game clients in a computer gaming network and the data is game data.

13. A method as claimed in claim 11, wherein the script is randomly created by a randomly selected peer and is distributed to the other peer(s), each peer being arranged to generate the same software code from the script.

14. A method as claimed in claim 11, wherein each peer creates part of a script for generating the software code and transmits it to the other peers, each said peer arranged to create a complete script from the received parts and use it to generate the same piece of software code, such that the software code is created cooperatively by the peers.

15. A method as claimed in claim 1, wherein the source apparatus is a server and the destination apparatus is a client, in a client-server system.

16. A method as claimed in claim 15 wherein the server is a game server, the client is a game client and the data is game data transmitted from the game server.

17. A method as claimed in claim 16 further comprising the client sending data to the server.

18. A method as claimed in claim 17 wherein the software code is also provided at the server.

19. A method as claimed in claim 18, wherein the software code is transmitted to the server from elsewhere.

20. A method as claimed in claim 18, wherein the software code is generated at the server.

21. A method as claimed in claim 16, wherein the software code is electronically signed upon creation, and wherein said destination apparatus comprises a certificate for verifying the signature on the software code, said destination apparatus being arranged to only execute the software code upon successful verification.

22. A method as claimed in claim 1, wherein the result of executing the software code enables the data to be accessed by providing a key which enables the data to be decrypted by or at the destination apparatus.

23. A method as claimed in claim 1, wherein the result of executing the software code enables the data to be accessed by providing information for generating a key which enables the data to be decrypted by or at the destination apparatus.

24. A method as claimed in claim 22, wherein the data sent to the server is encrypted by said key.

25. A method as claimed in claim 1 wherein the source apparatus is a transmission station and the destination apparatus is associated with a customer's receiving apparatus, the data comprising media content transmitted from the transmission station to the receiving apparatus.

26. A method as claimed in claim 25 wherein the software code is transmitted to the destination apparatus along with the media content.

27. A method as claimed in claim 25 wherein the software code is transmitted to the destination apparatus from a third party.

28. A method as claimed in claim 1, wherein the correct result used to access the data is only obtained if the destination apparatus is unmodified.

29. A method as claimed in claim 1, wherein the software code has a limited lifetime and when it expires a new one is created.

30. A method as claimed in claim 1, wherein the software code comprises an enforcement algorithm which calculates the result used to access the transmitted data, said result being necessary for the destination apparatus to access the data.

31. A method as claimed in claim 30 wherein said algorithm is a randomly created deterministic checksum algorithm.

32. A method as claimed in claim 30, wherein the software code further comprises one or more protection algorithms comprising hiding functions that are arranged to hide data in the destination apparatus thereby preventing an attacker from accessing said data.

33. A computer network comprising a first computer a second computer and a data path to enable data to be sent from the first computer to the second computer, wherein software code is provided at the second computer, the software code being arranged to produce a result which is a function of the state of the second computer and which result is used to access data sent to the second computer.

34. A computer network as claimed in claim 33, wherein the software code is transmitted to the second computer from elsewhere.

35. A computer network as claimed in claim 33, wherein the software code is generated at the second computer.

36. A computer network as claimed in claim 33, wherein the first computer is a game server, the second computer is a game client, and the data is gaming data.

37. A computer network as claimed in claim 33, wherein the first and second computers are game clients in a peer-to-peer gaming system and the data is game data.

38. A software product suitable for being transmitted to a remote apparatus whereby the execution of the software product at the remote apparatus provides a result which is a function of the state of the remote apparatus and which, if the result is satisfactory, enables access to data by the remote apparatus.

39. A software product suitable for being generated at a remote apparatus whereby the execution of the software product at the remote apparatus provides a result which is a function of the state of the remote apparatus and which, if the result is satisfactory, enables access to data by the remote apparatus.

40. A method carried out at a destination apparatus, the destination apparatus being provided with software code which is arranged to produce a result which is a function of the state of the destination apparatus; comprising: receiving data at the destination apparatus, executing the software code and using the result of the software code execution to access the received data.

41. A method as claimed in claim 40, further comprising receiving the software code from elsewhere.

42. A method as claimed in claim 40, further comprising generating the software code.

43. A destination apparatus arranged to receive data transmitted from a source apparatus, said destination apparatus being provided with software code which is arranged to produce a result which is a function of the state of the destination apparatus, and which result is used to access data received at the destination apparatus.

44. A destination apparatus as claimed in claim 43, arranged to receive software code transmitted from elsewhere.

45. A destination apparatus as claimed in claim 43, arranged to generate the software code.

46. A system comprising source and destination apparatuses and a data path to enable data to be sent from the source apparatus to the destination apparatus, wherein software code is provided at the destination apparatus, the software code being arranged to produce a result which is a function of the state of the destination apparatus and which result is used to access data sent to the destination apparatus.
